(19) United States
(12) Patent Application Publication
(10) Pub. No.: US 2024/0020566 A1
(43) Pub. Date: Jan. 18, 2024

(54) ON-CHIP QUANTUM COMPUTERS BASED ON CLASSICAL SYNTHESIZABLE DIGITAL CIRCUITS

(71) Applicant: Eonum Inc., Irvine, CA (US)

(72) Inventor: Olga Vlasova, Irvine, CA (US)

(73) Assignee: Eonum Inc., Irvine, CA (US)

(21) Appl. No.: 17/867,017

(22) Filed: Jul. 18, 2022

(51) Int. Cl. G06N 10/40; G06F 17/16

(52) U.S. Cl. CPC G06N 10/40; G06F 17/16

(57) ABSTRACT

The quantum computation principle is based on the phenomenon of superposition of states exhibited in specialized cells called quantum bits or qubits. Quantum computation potentially allows calculating multiple variants of the states (quasi) simultaneously. It is the major advantage of quantum computers over classical sequential processors where bits can take only a finite number of states and where algorithms are executed step by step, instruction by instruction from a program stored in a memory. It is fair to say that quantum computers are needed for a specific niche of tasks where classical computers are ineffective, e.g., exponentially growing algorithms.

The quantum bits and gates are currently implemented in physical devices, typically cryogenics, which require low-temperature tanks or other bulky equipment, such as superconducting magnets. As a result, even the latest quantum computers usually have no more than a few hundred qubits. Presently, the available quantum computers are unique experimental devices maintained in specialized labs not directly accessible to the users. The labs may lend the quantum computers' time to third parties for computations as a shared resource. On the contrary, classical computers are mass-produced, inexpensive, and readily available for personal use. The main reason for the difference in availability: traditional computers are built with integrated circuits (called chips) with millions of register bits. This level of integration, millions of bits per chip, is readily achievable even with today's technology.

The invention is intended to close this gap between classical computers and computers employing the quantum computation principle. The invention paves the way for implementing quantum computers based on existing integrated circuit technology. The invention creates an opportunity to manufacture quantum computers in electronic chips (integrated circuits) and mass production on existing semiconductor foundries producing regular integrated circuits. With the help of the invention, the quantum processors can be added as coprocessors to the existing classical processor chips or be standalone machines.

### BACKGROUND OF THE INVENTION

The Quantum computation principle is based on the phenomenon of superposition of states exhibited in specialized cells called quantum bits or qubits. The superposition of states means the simultaneous presence of the qubit in both orthogonal states |0> and |1>, albeit with some probability, not necessarily equal for both states. The main difference between the quantum computation from the classical one is based on the assumption that the superposition of qubit states gives more variants of the processed values than the classical register bit with its just two possible states, 0 and 1.

Combined with quantum gates, the qubits can be connected into circuits to address specific tasks. Once assembled in nets, such circuits are called quantum computers. The programs in these computers are effectively the connections between qubits and quantum gates. The result of the computation is extracted from the quantum computers by measuring the probability for different combinations of qubits' states in the computer's circuits.

Currently, the most common approach to quantum computation is based on using qubits implemented through physical phenomena such as the spin of electrons, polarization of light, etc. Practically, any elementary particles with observable states can be used as quantum bits. Some approaches to implementing qubits require low temperatures to keep the qubits' states intact. Others are not. But the current technology struggles with achieving the number of qubits in the quantum processor to be more than a hundred. The cooling equipment (for qubits based on fermions, such as electrons) or laser optics (for qubits based on bosons, such as photons) prevent effective miniaturization of the quantum computers. The proposed invention is a solution for miniaturization. The invented electronic circuits are perfectly suitable for implementing qubits and quantum gates based on the common semiconductor technique used for manufacturing the Application Specific Integrated Circuits (ASICs) working at room temperatures. The invented qubit circuits can also be prototyped on any Field Programmable Gate Array (FPGA) device, given that the FPGA device has a sufficient number of classical gates and register bits (flip-flops).

### BRIEF SUMMARY OF THE INVENTION

The invention describes the architecture of digital circuits to implement quantum bits' behavior and quantum gates' functionality. The invented circuits provide programmable control of quantum states superposition (states' probabilities) and the noise with a controllable level. This invention is a digital equivalent of a quantum processor. The invention includes the methodology to make the performance of the digital circuits potentially indistinguishable from the behavior of qubits based on physical phenomena.

The invention can work at room temperature and is easily replicated in digital ASICs and FPGAs. The suggested circuit can drastically increase the number of qubits achievable in quasi-quantum computers from hundreds to thousands. Additionally, the noise control in the invented circuit allows emulating both real and ideal (no noise) qubit behavior.

The code examples presented in the invention are written in the standard hardware design language Verilog. The code is suitable for synthesis and manufacturing quantum processors in classical integrated circuits. It is vital that the presented code is synthesizable: meaning the design can be converted into a combination of the standard integrated circuit (IC) library elements for further layout arrangement and photolithography on wafers. These are necessary technological steps toward the miniaturization of quantum computers.

It was said earlier that qubits combined with quantum gates form quantum computer circuits with specific architectures determined by the tasks. These connections form the “program” of the quantum computer. The result of quantum computation is extracted by measuring the probability for different combinations of qubits' states. An example of the probability measuring circuit is also presented in the invention.

The Quantum computation principle is based on the phenomenon of superposition of states exhibited in qubits. This superposition is a simultaneous presence of the qubit in both orthogonal states, for example, |0> and |1>. The underlying idea of the invention is the next: the superposition of states can be viewed as a process where the qubit quickly switches between two orthogonal states |0> and |1> with some probability distribution between those two states. The faster the alteration of states—the closer the circuit's behavior is to the real physical qubit device behavior. The invention describes the fast switching qubit emulation solution, which can still be implemented with standard digital chip technology. For example, at digital clock frequencies above 2 GHz, the behavior of the digital emulator will be indistinguishable from its physical counterpart based on electron spin switching.

The invention provides a solution for building quantum computers based on digital modules with standard semiconductor components. The target of quasi-quantum computation is achieved by probability quantization of orthogonal states |0> and |1>, which can be modulated in a qubit as a superposition of states. Moreover, the superposition of orthogonal states in the invented circuit is also accompanied by the introduction of the regulated noise conveniently implemented in the same quantizer of orthogonal states. In other words—one invented quantizer produces the programmable superposition of the states |0>, |1> and the controllable injection of the noise (random |0> or |1>).

### BRIEF DESCRIPTION OF THE SEVERAL VIEWS OF THE DRAWING

FIG. 1 contains a simplified block diagram of the probability modulator, which comprises the following main parts: linear feedback shift register 1, disturber 2, quantizer (comparator) 3.

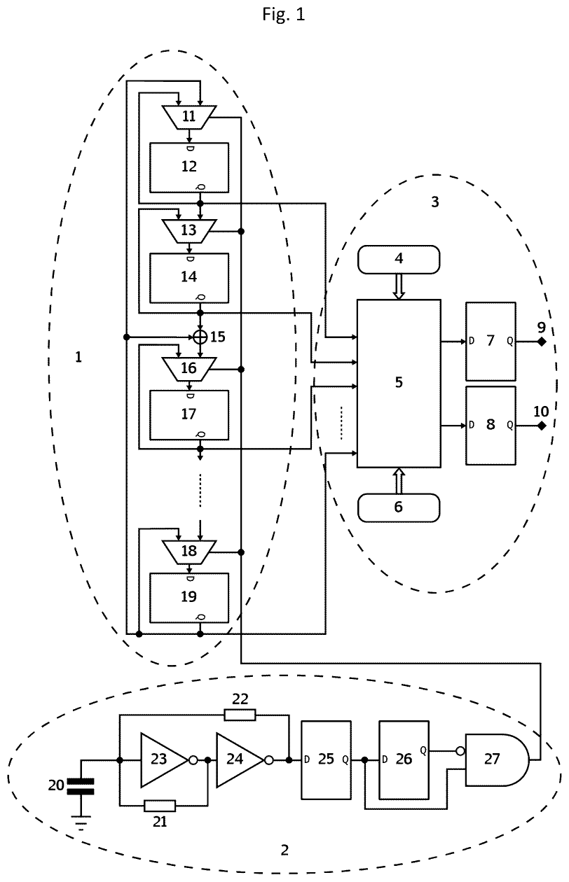

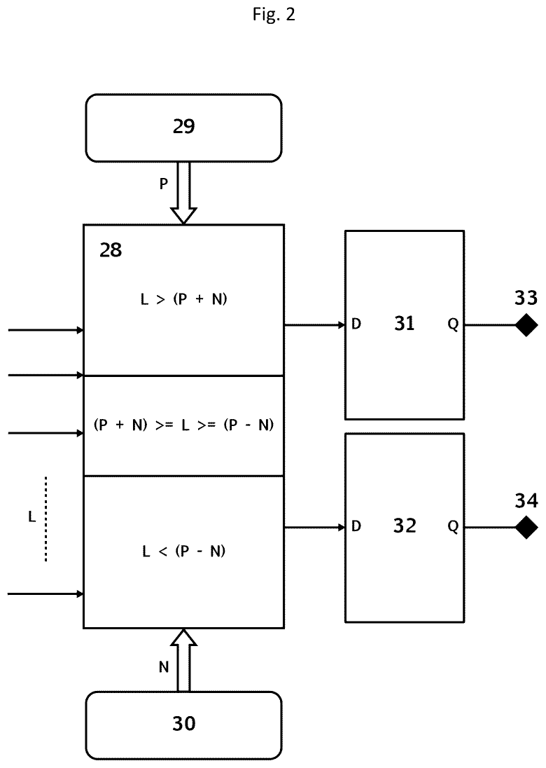

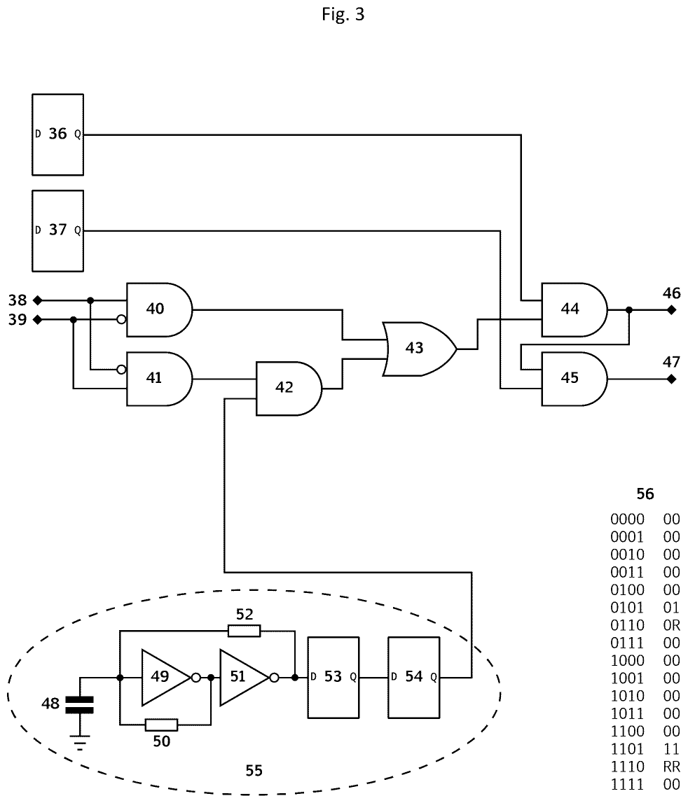

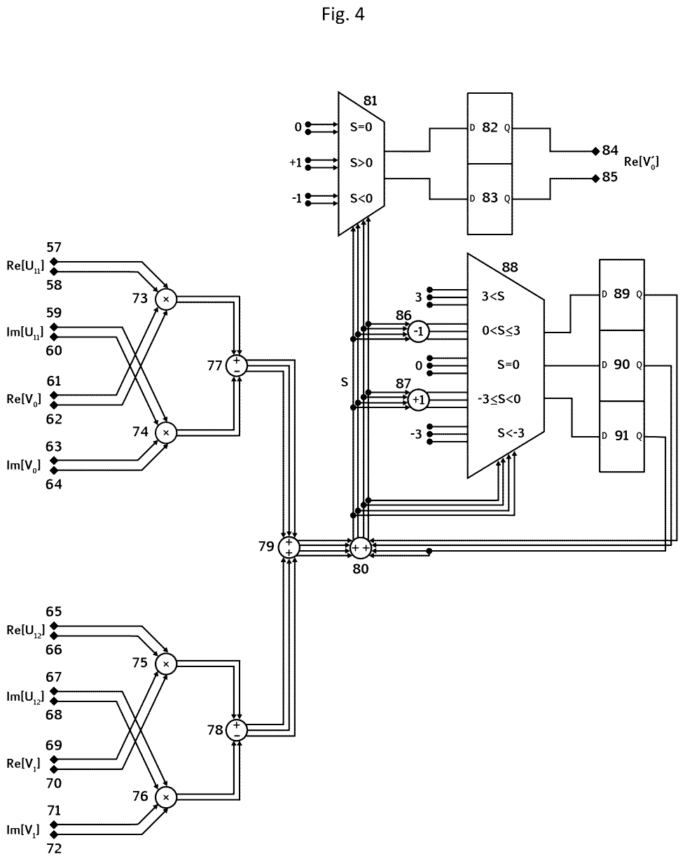

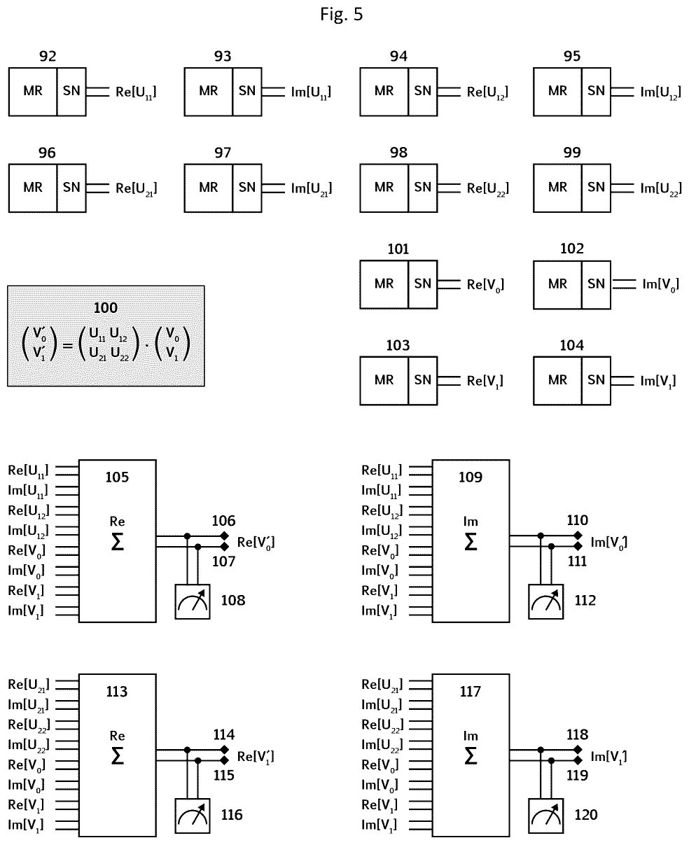

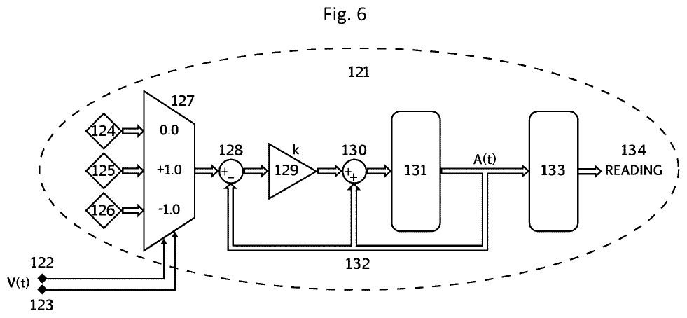

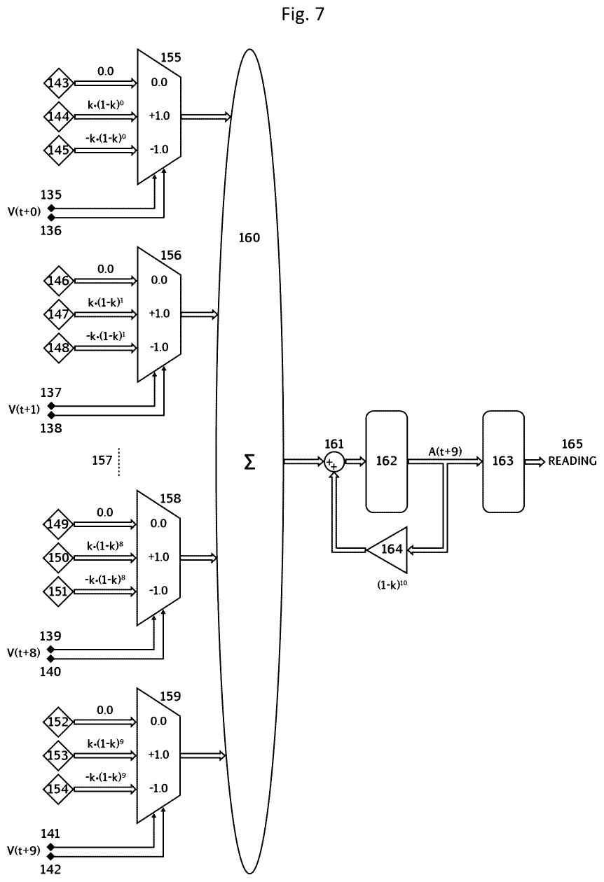

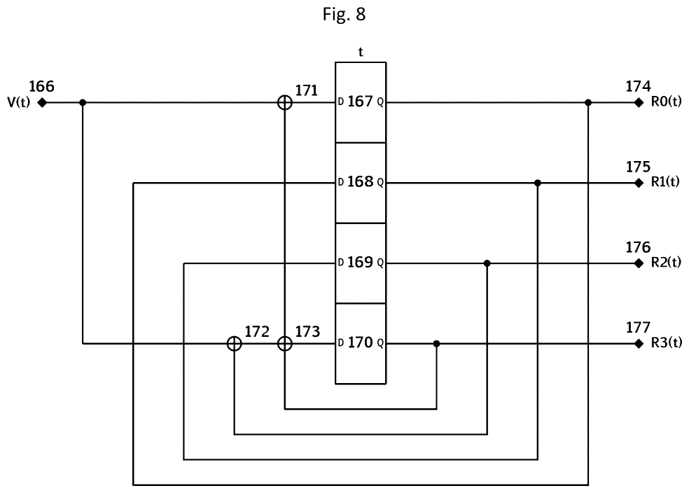

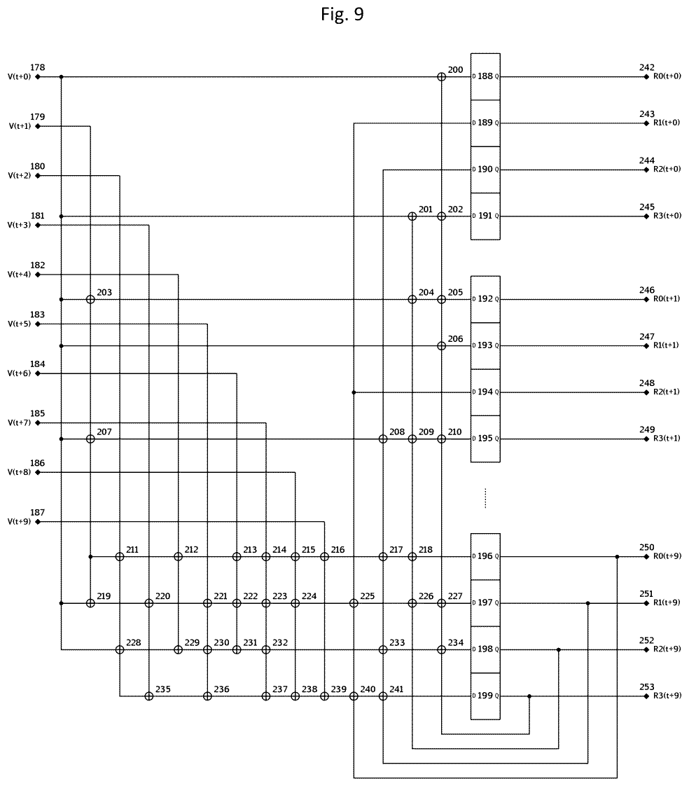

Linear feedback shift register 1 consists of m individual flip-flop bits, where number m is design dependent, typically 16. Only 4 flip-flops out of m bits are shown in FIG. 1, marked as 12, 14, 17 and 19. Linear feedback shift register 1 is a generator of pseudo-random numbers. Feedbacks are made via exclusive OR elements (XOR gates) shown in FIG. 1 as element 15. A set of m multiplexers 11, 13, 16, and 18 has been added to generate a truly random number.

The multiplexers are controlled by disturber 2 output. Disturber 2 comprises two inverters, 23 and 24, two flip-flops, 25 and 26, and logic AND gate 27. Inverter 23 acts as an RC oscillator whose period of oscillations is determined by capacitor 20 and resistor 21. Inverter 24 and resistor 22 form a Schmitt trigger for better stability of RC oscillator based on inverter 23. Flip-flops 25, 26, and logic gate 27 produce a single pulse on the output of gate 27 every time there is a transition from logical 0 to logical 1 on the output of flip-flop 25. Gate 27 output pulses go to the multiplexers 11, 13, 16, and 18, which prevent linear feedback register 1 from advancing to the new value at random moments of time because the RC oscillator is independent of a clock used in flip-flops 12, 14, 17, 19, 25 and 26.

The current value of the linear feedback shift register 1 is compared in the quantizer 3 comparator 5 using values stored in two registers, 4 and 6. The programmable state probability setting register 4 and programmable probability noise register 6 usages are presented in FIG. 2. The comparison result is two bits which go to flip-flops 7 and 8 and then to the outputs 7 and 8 of the quantizer and modulator as a whole.

FIG. 2 describes in detail the design of quantizer 3 from FIG. 1. The quantizer consists of comparator 28, programmable state probability setting register 29 (same as 4 in FIG. 1), and programmable noise probability register 30 (same as 6 in FIG. 1). The comparator 28 performs the comparison of the current value in the linear feedback shift register (LFSR) shown as 1 in FIG. 1 with values stored in the registers 29 and 30. Under the assumption that L represents the current LFSR value, P represents value in the register 29, and N represents value in the register 30, the result of the comparison is coded in two bits as follows:
L>(P+N) result is binary 11;
(P+N)>=L>=(P−N) result is binary 10;
L<(P−N) result is binary 01.

Two bits of the result go to inputs of two flip-flops, 31 (least significant bit) and 32 (most significant bit). The flip-flops can also take the reset value of binary 00. Therefore, on quantizer outputs 33 (same as 9 in FIGS. 1) and 34 (same as 10 in FIG. 1), all four binary combinations are possible 00, 01, 10, 11.

The combinations are treated as follows (table 35 on FIG. 2):
00—UNKNOWN or INITIAL state;
01—PROBABLE state |p>;
10—RND (random noise: state |p> or state |b>);
11—IMPROBABLE state |b>.

The usage of the term PROBABLE (marked as state |p>) is related to the fact that invented modulators are made identical for a different generation of state 10> and state |1>, their real and imaginary components. Effectively, the term PROBABLE is a placeholder for usage of Re[|0>], Im[|0>], Re[|1>], Im[|1>]. Meanwhile, IMPROBABLE state |b>negates PROBABLE state |p>. Other variants of the assignment between binary coding and quantum state representations are allowed and equally suitable.

Each quantum bit needs 4 identical modules (for the real and imaginary parts of state |0> and the real and imaginary components of state |1>). Each such module should contain the probability modulator depicted in FIG. 1 and the logic from FIG. 3 for setting the polarity of the probability and for the optional injection of the noise. Again, this combination is a quarter of what is needed for implementing one quantum bit. For the Unitary quantum gate (matrix 2×2), the above hardware should be repeated 8 times; for the dual quantum gate (matrix 4×4), the hardware is multiplied by a factor of 32, and so on. The quantum gates often do not require probability modulators (FIG. 1) if the gate's matrix contains static elements {0, +1, −1} without the need for phase change. Nevertheless, the invented design covers the most general case—every element of the gate matrix and every component of the qubit state vector are assumed to have both real and imaginary parts.

FIG. 3 shows the polarity logic, which includes two programmable register bits, 36 and 37. The register bits determine the coefficient from a set of values {0, +1,−1} combined with an absolute amplitude of probability provided by the probability modulator (from FIG. 1) via inputs 38 and 39. The inputs 38 and 39 are directly connected to the probability modulator's outputs 9 and 10 from FIG. 1. Combinatorial gates 40, 41, 42, 43, 44, and 45 are implemented in table 56 to assign the probability amplitude polarity and to accommodate an insertion of a random value RND through the noise injection circuit 42. The noise injection circuit is supplied with the random value by the random bit generator 55. Architecturally, the random bit generator 55 is similar to the disturber 2 in FIG. 1. Both 55 and 2 run independently from each other.

Random bit generator 55 comprises two inverters, 49 and 51, and two flip-flops, 53 and 54. Inverter 49 acts as an RC oscillator whose period of oscillations is determined by capacitor 48 and resistor 50. Inverter 51 and resistor 52 form a Schmitt trigger for better transition stability of RC oscillator based on inverter 49. Flip-flops 53 and 54 form a chain of registers to produce a stable yet random bit value of 0 or 1 on wire RND, which goes to gate 42 for the noise injection to the final outputs 46 and 47. The value from outputs 46 and 47 can go to other quantum gates for further data processing or can be used to measure the state's superposition probability if this quantum gate is the final in the chain representing the quantum task (algorithm). A thorough description of the polarity logic and noise injection logic is provided in the detailed description of the invention.

FIG. 4 addresses the multiplication (dot product) implementation between a matrix 2x2 of unitary gate U with a vector V representing a quantum bit state. The quantum gate U transforms qubit current state V into a new quantum bit state denoted by vector V′, specifically V′=U·V. The invented part here is the normalization of the dot product V′ to the same bit width as the width of the input vector V. This approach allows limitless connections of quantum gates in chains without exponential growth of the hardware. The detailed description of the invention discusses the math related to the complete task of multiplication of gate matrix and state vector.

The values from the gate matrix terms are supplied via inputs grouped in 2 bits pairs 57-58, 59-60, 65-66, and 67-68. The qubit state values are provided through inputs 61-62, 63-64, 69-70, and 71-72. All these signals go to the signed arithmetic multipliers 73, 74, 75, and 76, followed by subtractors 77 and 78, intermediate adder 79, and the final adder 80. The final adder 80 combines the current dot product result with the residue from the previous operations stored in the flops 89, 90, and 91. These flops are fed with values from multiplexor 88, which limits the residue to the range of −3 to +3, while the sum S can be anywhere from −7 to +7. Finally, the sign of the sum S and its non-zero value is evaluated in the multiplexor 81. Flops 82 and 83 store the output value which takes values {0, +1, −1} on outputs 84 and It is essential that the bit width of the final result 84, 85 is the same as the bit width of every input (e.g., 57, 58, etc.). This property is important for connecting the invented logic into chains of gates and qubits with an unlimited length of chains.

FIG. 5 illustrates the most straightforward quantum processor: a circuit transforming one qubit state vector V into another quantum state V′ via unitary quantum gate U. This transformation is mathematically expressed in a dot product formula 100 on FIG. 5. This figure is a collection of the hardware needed for implementing the dot product 100. The qubit state vector V needs four identical parts, 101, 102, 103, and 104, to represent vector's V, each state |0> and |1>real and imaginary components. Each part (e.g., 101) is a combination of probability modulator (denoted MR in FIG. 5, detailed in FIG. 1), polarity logic, and noise injection logic (marked as SN in FIG. 5, depicted in FIG. 3).

On the other hand, the unitary matrix U requires 8 modulator parts 92, 93, 94, 95, 96, 97, 98, and 99 because the matrix has dimension 2x2, and each matrix term needs a real and an imaginary component. Then, the dot product (multiplication and summation) is performed in four modules 105, 109, 113, and 117. The dot product is demonstrated in FIG. 4. There are slight differences between modules 105 and 113 for the real components vs. modules 109 and 117 for the calculations of the imaginary part. The deviations will be discussed in the detailed description of the invention. The resulting vector V′ is produced on outputs (each output group is two-bit wide) 106-107, 110-111, 114-115, and 118-119. The outputs can be connected to the next quantum gate in the quantum processor chain or measured directly on the outputs, as shown in FIG. 5. The probability measuring devices are marked as items 108, 112, 116, and 120.

FIG. 6 depicts such probability measuring device 121 architecturally, an r-bit wide digital integrator. The integrator is designed to measure the amplitude of the probability of the qubit state. As shown in FIG. 5, to fully measure the qubit state, four measuring devices, 108, 112, 116, and 120 are required for state |0> real and imaginary part and state |1> real and imaginary part. The measuring devices are identical to module 121.

The measuring device 121 has a two-bit input 122-123 which takes toggling values of {0, +1, −1} for a measurement from outputs of the circuits similar to 106-107, 110-111, 114-115, 118-119 from FIG. 5. The measuring device determines the amplitude of probability by averaging the frequency of events +1 and −1 on its input. To convert the input value from set {0, +1, −1} to the r-bit basis, the integrator is provided with an input value multiplexor 127, switching between the constant value of zero (item 124, where all r bits are zeros 000 . . . 000), constant value +1.0 of full scale (item 125, where r bits are 011 . . . 111) and constant value −1.0 of full scale (126, where r bits are 100 . . . 001). Differentiator 128, attenuator 129, adder 130, accumulator 131 and the feedback 132 from accumulator 131 to the differentiator 128 and adder 130 are needed to implement an overall mathematical expression for the accumulator's 131 next value A(t+1) at moment t+1 (current time t plus one clock) as A(t+1)=k(V(t)−A(t))+A(t)=k·V(t)+(1−k)·A(t), where A(t) is the accumulator's current value, V(t) is an input value to be measured and k is an attenuation coefficient. The output register 133 is used as a buffer for reading the current value in accumulator 131 by the host computer via output 134. The detailed description of the inventions provides more information about the measurement of probability amplitude.

FIG. 7 is a transformation of the measuring device from FIG. 6 to the parallel multi-cycle quantum processing method, which allows calculating multiple measurements in a single clock. It accelerates the calculations, albeit requires more hardware. If some module does not contain circuits that can memorize the intermediate results (like registers), then acceleration can be achieved by simply repeating the hardware. But if the circuit possesses the memory elements, the accelerated solution is more complicated and requires additional nets.

The measuring device from FIG. 6 is a module with a memory element, the accumulator 131. The presence of the memory element requires an expansion of hardware if parallel calculations are required. The multi-cycle expansion (for example, for acceleration with 10 parallel measurements in a single clock) needs a total of 10 input multiplexors 155, 156, 157 (represents six not depicted multiplexors), 158, 159 controllable by the input pairs 135-136, 137-138, . . . , 139-140, 141-142. Input values have different weights coded with positive and negative constants 144, 145, 147, 148, . . . , 150, 151, 153, 154. Each input is provided with a zero constant 143, 146, . . . , 149, 152. The measuring device contains accumulator 163, feedback gain 164, adder 161, and summer 160 of the input values with different weight coefficients. The output register 163 allows the host computer to read the measurement result via output 165. The full description of the measuring device with parallel calculations is provided in the detailed description of the invention.

FIG. 8 depicts an example of an abstract 4 bits scrambler circuit later accelerated tenfold with a parallel calculation method, meaning multiple operations per one clock. FIG. 8 contains memory elements (register bits) 167, 168, 169 and 170 and CNOT (controllable NOT) gates 171, 172 and 173. The scrambler makes one operation per one clock. A general input 166 provides input value V(t) to be scrambled. Scrambling results are available on outputs 174, 175, 176, and 177. The work of the scrambler will be discussed in the detailed description of the invention.

The result of the acceleration of the scrambler from FIG. 8 using the parallel calculation method is shown in FIG. 9. It illustrates the same circuit with memory elements (register bits) depicted in FIG. 8 but expanded for multi-stage calculations (multiple parallel calculations per single clock cycle). FIG. 9 shows the hardware needed to reach 10 iterations (shifts) per single clock. The method of parallel calculations, which will be discussed in the detailed description of the invention, allows digital circuits to mimic the behavior of the real quantum processors and approach their performance in real-time. The four bit register R0, R1, R2, R3 is split (repeated) in 10 timing strata {R0(t+0), R1(t+0), R2(t+0), R3(t+0)}, {R0(t+1), R1(t+1), R2(t+1), R3(t+1)}, . . . , {R0(t+9), R1(t+9), R2(t+9), R3(t+9)} which are respectively marked as items 188, 189, 190, 191, 192, 193, 194, 195, . . . , 196, 197, 198, 199. The input 10 consecutive values V(t+0), V(t+1), V(t+2), V(t+3), V(t+4), V(t+5), V(t+6), V(t+7), V(t+8), V(t+9) are also provided in parallel on inputs 178, 179, 180, 181, 182, 183, 184, 185, 186 and 187. Multiple CNOT (controllable NOT) quantum gates (marked as items 220, 201, . . . , 240, 241) are required to implement in the scrambler circuit 10 shifts in a single clock. The underlying formulas will be discussed in the detailed description of the invention. The values of the scrambler register bits at 10 consecutive times t+0, t+1, . . . , t+9 are available on outputs 242, 243, 244, 245, 246, 247, 248, 249, . . . , 250, 251, 252, 253. On the next clock, the same outputs (242, 243, 244, 245, 246, 247, 248, 249, . . . , 250, 251, 252, 253) will hold scrambler register values corresponding to the time stamps t+10, t+11, . . . , t+19, and so on.

### DETAILED DESCRIPTION OF THE INVENTION

The invention provides a solution for building digital components for quantum computation which solves its major limitation: the number of quantum bits. The invention aims to provide a path for controlling qubits' states to implement a quantum computation principle using current semiconductor technology suitable for miniaturization. The target is achieved by probability quantization of orthogonal states |0> and |1>, which can be modulated in a qubit as a superposition of states. The invention also allows adding noise with a controllable level to each qubit to match the behavior of real physical phenomena used in the lab quantum computers.

The invention describes the designs of the quantum bit, the quantum gate, their combination, and finally, the probability measuring module. These modules comprise the base for quantum computation. The invention also addresses a method of parallel computation using the invented circuit. The technique allows integrated circuits to reach the performance of quantum bits based on physical phenomena.

The detailed description of the invention should be started with an explanation for implementing a quantum bit. The invented quantum bit circuit is implemented as a probability modulator which creates a process of alternation between two states: probable |p> and improbable |b>. The alteration rate is programmable and effectively represents the absolute amplitude of probability. Later on, a polarity logic will be added to the modulator's output to place the resulting amplitude of probability in the range (−1.0 . . . +1.0). To expand the probability values to the complex plane (−1.0·i . . . +1.0·i), a second set of the probability modulator and the polarity logic is required for each qubit.

The modulator is depicted in FIG. 1. It works as a random generator of orthogonal states |p> and |b>with a controllable probability of their superposition. Linear feedback shift register (or LFSR) 1 produces pseudo-random m-bit numbers every clock feeding the shift register 1. The value of register 1 is shifted simultaneously in all flip-flops 12, 14, 17, and 19. For example, the value of flip-flop 12 goes to flip-flop 14. Simultaneously the value of flip-flop 14 is transferred to the flip-flop 17 and so on until the last flip-flop 19, where it is returned (fed back) to flip-flop 12 and to flip-flop 17 via exclusive XOR gate 15. The insertion of an exclusive XOR gate between flops 14 and 17 for feedback is given as an example. The actual width of the shift register and its feedback selection can differ from the shown example. There are underlying LFSR rules (public knowledge) for selecting the feedback architecture for the shift register to cover all 2^{m}-1 numbers (except zero value). The line feedback shift register 1 can be initialized to any non-zero value. The implementation of the LFSR uses the width m=16 and polynomial x¹⁶+x¹²+x⁵+1.

To create a truly random set of numbers, disturber 2 sends pulses that randomly stop the linear feedback register from advancing. To prevent the shift register from shifting, the multiplexors 11, 13, 16, and 18 are added on inputs for each flip-flop 12, 14, 17, and the last flip-flop 19. When disturber 2 generates a pulse with one clock duration, the multiplexors switch the flip-flops' inputs to their respective outputs. Thus, if the disturber's output is logical 1 for one clock, the line feedback shift register skips a shift for one clock.

The disturber is based on an RC auto-generator implemented on inverter 23. The frequency f of the disturber's oscillation is determined as a reciprocal of the RC product, where R is the resistor 21 value and C is the capacitance of capacitor 20. Therefore, the RC oscillator's frequency can be calculated as f=1/(R·C). The optimal frequency for the disturber should be selected as a frequency approximately 4 times slower than the frequency of the clock feeding the flip-flops. The fact that the frequency of RC oscillation is independent of the clock providing flip-flops while fluctuating with changes in temperature and power supply voltage is beneficial for the oscillation's true randomness.

Second inverter 24 in the disturber is needed to avoid jittering in the RC oscillator transitions. It provides positive stabilizing feedback on the input of inverter 23 via resistor 22. The value of resistor 22 should be approximately 10 times bigger than the value of resistor 21 not to suppress the oscillation itself. The synthesizable RC oscillator is a standard cell in majority of digital libraries.

The output of inverter 24 is connected to the input of flip-flop 25, which is connected to the input of flip-flop 26. Together with AND gate 27, flip-flops 25 and 26 form a circuit that generates a pulse with a duration of one clock every time the output of flip-flop 25 transitions from logical 0 to logical 1. It is achieved by inversion on the top input of the AND gate 27. The circuit will also work if flip-flop 25 output transitions from logical 1 to logical 0 are used. In this case, the second input of gate 27 should be inverted instead of its first input. After all, the m-bit random numbers generated by a linear feedback shift register 1 and disturber 2 go to quantizer 5 for comparison with the m-bit value programmed in the probability setting register 4 and noise level setting register 6.

FIG. 2 describes in detail the design of quantizer 5 from FIG. 1. The quantizer consists of comparator 28, programmable state probability setting register 29 (same as 4 in FIG. 1), and programmable probability noise register 30 (same as 6 in FIG. 1). The comparator 28 compares the current value L of the linear feedback shift register (item 1 in FIG. 1) with values stored in registers 29 and 30. There are three ranges of comparison in the quantizer. Under the assumption that L represents the LFSR value, P represents value in the register 29, and N represents value in the register 30, the result of the comparison is coded in two bits:
L>(P+N) result is binary 11;
(P+N)>=L>=(P−N) result is binary 10;
L<(P−N) result is binary 01.

Two bits of the result go to inputs of two flip-flops, 31 (least significant bit) and 32 (most significant bit). The flip-flops can also take the reset value of binary 00. So, on quantizer outputs 33 (same as 9 in FIGS. 1) and 34 (same as 10 in FIG. 1), all four binary combinations are possible 00, 01, 10, 11.

The output 33, 34 combinations 35 are treated as follows:
00—UNK (unknown state);
01—probable state |p>;
10—RND random noise: equally spread between probable state |p> and improbable state |b>;
11—improbable state |b>.

The usage of the term PROBABLE (marked as state |p>) is related to the fact that invented modulators are made identical for a different generation of state |0> and state |1>, their real and imaginary components. Effectively, the term PROBABLE is a placeholder for usage of Re[|0>], Im[|0>], Re[|1>], Im[|1>]. Meanwhile, IMPROBABLE state |b>negates PROBABLE state |p>. Other variants of the assignment between binary coding and quantum state representations are allowed and equally suitable. Other variants of the assignment between binary coding and quantum state representations are allowed and equally suitable. If the LSFR is m-bit wide, it generates 2^{m}-1 random numbers. Thus, the amplitude of probability of state |p> is (P-N)/(2^{m}−1), and the amplitude of probability of state |b> is (1-P-N)/(2^{m}−1). The likelihood of noise is the rest 2·N/(2^{m}−1).

The above circuit provides an absolute value of probability amplitude. The quantum tasks require extension of probability amplitude into positive—negative real (−1.0 . . . +1.0) and imaginary planes (−1.0 i . . . +1.0 i). For this purpose, the polarity logic needs to be added. FIG. 3 depicts a polarity logic combined with an optional noise injection circuit. The module architecturally consists of two classical register bits, 36 and 37, for setting the polarity, logic gates 40, 41, 42, 43, 44, 45, and the random bit generator 55.

Architecturally, the random bit generator 55 is similar to the disturber 2 in FIG. 1. Random bit generator runs independently from disturber 2. Random bit generator 55 comprises two inverters, 49 and 51, and two flip-flops, 53 and 54. Inverter 49 acts as an RC oscillator whose period of oscillations is determined by capacitor 48 and resistor 50. Inverter 51 and resistor 52 form a Schmitt trigger for better stability of RC oscillation transitions. Flip-flops 53 and 54 form a chain of registers to produce a stable yet random bit value 0 or 1 on a wire, which goes to gate 42 for the noise injection to the module's output 46. The two bits output values 46, and 47 are used in quantum gates and quantum bits as described later in the detailed description of the invention.

FIG. 4 depicts an implementation of a dot product which is a part of any quantum gate. FIG. 4 addresses the multiplication (dot product) implementation between a matrix 2×2 of unitary gate U with a vector V representing a quantum bit state. The quantum gate U transforms qubit current state V into a new quantum bit state denoted by vector V′, specifically V′=U·V. The invented part here is the normalization of the dot product V′ to the same bit width as the width of the input vector V. This approach allows limitless connections of quantum gates in chains without exponential growth of the hardware. The detailed description of the invention discusses the math related to the complete task of multiplication of gate matrix and state vector.

The dot product V′=U·V can be split into two similar sums of multiplications V₀′=U₁₁·V₀+U₁₂ V₁ and V₁=U₂₁·V₀+U₂₂·V₁. It comes directly from the matrix form:

$$( \begin{matrix}{V}_{0}^{′} \\ {V}_{1}^{′}\end{matrix} ) = ( \begin{matrix}{U}_{11} & {U}_{12} \\ {U}_{21} & {U}_{22}\end{matrix} ) \cdot ( \begin{matrix}{V}_{0} \\ {V}_{1}\end{matrix} )$$

Each element of the multiplicands is a complex number containing real Re[*] and imaginary Im[*] parts.

For example U₂₁=0.8+0.6 i, where i—is imaginary unit satisfying condition i 2=−1. Here Re[U₂₁]=0.8 and Im[U₂₁]=0.6.

The dot product for V₀′ can be rewritten as follows:

V₀′=U₁₁′·V₀+U₁₂·V₁₌(Re[U₁₁]+Im[U₁₁]·i)(Re[V₀]+Im[V₀]·i)+(Re[U₁₂]+Im[U₁₂]·i)(Re[V₁]+Im[V₁]·i)=Re[U₁₁]·Re[V₀]−Im[U₁₁]Im[V₀]+Re[U₁₂]·Re[V₁]−Im[U₁₂]·Im[V₁]+(Re[U₁₁]·Im[V₀]+Im[U₁₁]·Re[V₀]+Re[U₁₂]·Im[V₁]+Im[U₁₂]·Re[V₁])i=A+B i.

Similar for V₁′:

V₁′=U₂₁V₀+U₂₂V₁₌(Re[U₂₁]+Im[U₂₁]·i)(Re[V₀]+Im[V₀]·i)+(Re[U₂₂]+Im[U₂₂]·i)(Re[V₁]+Im[V₁]·i)=Re[U₂₁]·Re[V₀]−Im[U₂₁]·Im[V₀]+Re[U₂₂]·Re[V₁]−Im[U₂₂]·Im[V₁]+(Re[U₂₁]·Im[V₀]+Im[U₂₁]·Re[V₀]+Re[U₂₂]·Im[V₁]+Im[U₂₂]·Re[V₁])·i=C+D·i.

The invented circuit limits the input range for the multiplicands to the set of only 3 possible values {0, +1, −1}. That is why the multiplication of two operands (for example, Re[Un]·Re[V₀]) does not increase the bit width of the product. The result of multiplication will always be 0 or +1, or −1. On the other hand, the addition and subtraction of the multiplication products require more bit width for calculations to avoid overflow or underflow of the arithmetic result.

The real part A of the dot product is:

A=Re[V₀′]=Re[U₁₁]·Re[V₀]−Im[U₁₁]·Im[V₀]+Re[U₁₂]·Re[V₁]−Im[U₁₂]·Im[V₁]

and the imaginary part B of the dot product is

B=Im[V₀′]=Re[U₁₁]·Im[V₀]+Im[U₁₁]·Re[V₀]+Re[U₁₂]·Im[V₁]+Im[U₁₂]·Re[V₁].

Parts A and B, in the general case, need two additional bits each for the width because expressions A and B can reach a value of +4 or be −4. The invented hardware not only implements the said multiplication and addition, but it also normalizes the final result of the summation back to the width of 2 bits without loss of information. FIG. 4 shows the circuit needed for the expression A implementation. Similar hardware is required for the imaginary part B of V₀′. And for the second part of the qubit state vector V₁=C+D·i, the hardware is doubled again.

The values from the gate matrix terms are supplied via inputs (grouped into 2 bits pairs) 57-58, 59-60, 65-66, and 67-68. The qubit state values are provided through inputs 61-62, 63-64, 69-70, and 71-72. The specific pairs of the operands for the expression A are multiplied arithmetically in four signed two-bit multipliers 73, 74, 75, and 76, as shown in FIG. 4. The multiplication is followed by logic consisting of subtractors 77 and 78, an intermediate adder 79 and by the final adder 80 for combining the result of the dot operation with the residue from the previous clock cycle stored in the flops 89, 90 and 91.

These flops are provided with values from multiplexor 88. This multiplexor limits the value on inputs of flops 89, 90, and 91 to the range of −3 to +3, while the sum S can take any value in the range from −7 to +7. The buffering registers 89, 90, and 91 allow postponing and redistributing the value of the sum S for the later clock cycles to avoid increasing the output bit width. This property of conservation of the dot product output bit width is important for connecting the invented logic elements into chains of gates and qubits with an unlimited length of the chains. Finally, the sign of the sum S and its non-zero value is evaluated in the multiplexor 81. Flops 82 and 83 store the output value which can be {0, +1, −1} on outputs 84 and 85. It is essential that the bit width (two bits) of the final result Re[V₀′] on outputs 84, 85 is the same as the bit width (two bits) of every input, e.g., Re[U_{11_}] (57, 58).

The implementation of the dot product for expression B is very similar to the design of the circuit representing expression A. However, there are the following differences: subtractors 77 and 78 are replaced by the adders, and output Re[V₀′] on 84 and 85 is renamed Im[V₀′]. For expressions C and D, the hardware described for implementation of expressions A and B has been repeated for outputs Re[V₁′] and Im[V₁′], respectively, as follows:

C=Re[V₁′]=Re[U₂₁]·Re[V₀]−Im[U₂₁]·Im[V₀]+Re[U₂₂]·Re[V₁]−Im[U₂₂]Im[V₁]

D=Im[W]=Re[U₂₁ ]·Im[V₀]+Im[U₂₁]·Re[V₀]+Re[U₂₂]Im[V₁]+Im[U₂₂]·Re[V₁]

It is essential that the same invented approach to the dot product (normalization of the results to the limited set of values, for example {0, +1, −1}) is extended and claimed for the quantum gates with two, three, etc. inputs. For the quantum gates with two inputs (e.g., CNOT, controllable NOT gate) with the matrix form shown below, the implementation of the dot product will require 4 multiplication and addition chains with 4 complex multiplicands in each chain.

$$( \begin{matrix}{V}_{00}^{′} \\ {V}_{01}^{′} \\ {V}_{10}^{′} \\ {V}_{11}^{′}\end{matrix} ) = ( \begin{matrix}{U}_{11} & {U}_{12} & {U}_{13} & {U}_{14} \\ {U}_{21} & {U}_{22} & {U}_{23} & {U}_{24} \\ {U}_{31} & {U}_{32} & {U}_{33} & {U}_{34} \\ {U}_{41} & {U}_{42} & {U}_{43} & {U}_{44}\end{matrix} ) \cdot ( \begin{matrix}{V}_{00} \\ {V}_{01} \\ {V}_{10} \\ {V}_{11}\end{matrix} )$$

The chains for the quantum gate with 2 inputs are built in the same invented manner as circuits for the single input quantum gate circuit depicted in FIG. 4.

FIG. 5 illustrates the most straightforward quantum processor: a circuit transforming one qubit state vector V into another quantum state V′ via unitary quantum gate U. This transformation is mathematically expressed in a dot product formula 100 on FIG. 5:

$$( \begin{matrix}{V}_{0}^{′} \\ {V}_{1}^{′}\end{matrix} ) = ( \begin{matrix}{U}_{11} & {U}_{12} \\ {U}_{21} & {U}_{22}\end{matrix} ) \cdot ( \begin{matrix}{V}_{0} \\ {V}_{1}\end{matrix} )$$

In a scalar form, the dot product can be expressed as follows:

V₀′=U₁₁·V₀+U₁₂·V₁

V₁′=U₂₁·V₀+U₂₂·V₁

The qubit state vector V has two scalar components, V₀ and V₁, representing states 10> and 11>, respectively. Additionally, each component, V₀, and V₁, has real and imaginary parts. The identical 101, 102, 103 and 104 parts are associated with the following vector's V terms: Re[V₀], Im[V₀], Re[V₁], Im[V₁]. Each part (e.g., 101) is a combination of probability modulator (denoted MR in FIG. 5, detailed in FIG. 1), polarity logic, and noise injection logic (marked as SN in FIG. 5, depicted in FIG. 3).

The unitary matrix U has four terms, U₁₁, U₁₂, U₂₁, and U₂₂, each with real and imaginary components. Thus, matrix U requires 8 modulator parts 92, 93, 94, 95, 96, 97, 98, and 99. Then, the dot product (multiplication and summation) is performed in four modules 105, 109, 113, and 117. The dot product was detailed in FIG. 4. The slight differences between modules 105 and 113 for the real components vs. modules 109 and 117 for the calculations of the imaginary component were discussed previously.

The resulting vector V′ contains two components V₀′ and V₁′, representing quantum state |0> and state |1>, respectively. Each element has real and imaginary parts. Thus, the result of formula 100 transformations produces four groups of outputs (each group is two bits) 106-107, 110-111, 114-115, and 118-119. The outputs can be connected to the next quantum gate in the quantum processor chain, or they can be measured directly on the outputs, as shown in FIG. 5. The probability measuring devices are marked as items 108, 112, 116, and 120 and will be discussed below.

FIG. 6 illustrates the block diagram for the probability measuring device. The work of the measuring device is based on an accumulator, which consists of r-bit register 131 and adder 130. The left input of adder 130 provides values added to the accumulator's value. This left input of 130 is connected to the output of attenuator 129. Attenuator 129 diminishes the amplitude of the signal obtained from the differentiator 128 output. The coefficient of attenuation k determines the integration time as 1/(f·k), where f is the frequency of the system clock.

Several bits r in accumulator 131 may be selected as the sum of w bits determined by the required resolution of the results and the number of extra bits x needed to accommodate the attenuation coefficient k. For example, if a resolution of the result is required to be 1%, then w=7 bits will be enough because 0.01≈1/2 7. Again, for example, if the attenuation coefficient is chosen k=0.01, it will require extra x=7 binary bits because k=0.01≈1/2 7. Thus, r=w+x=7+7=14.

Differentiator 128 subtracts the incoming values from the output of multiplexor 127 and accumulator 131 current values. Multiplexor 127 switches its output between constant 124, 125, and 126 based on two bits input pair 122-123, which is fed by an output of the measured circuit (for example, 106-107 pair from FIG. 5). If the value on input 74 is logical 0 then constant 76 is selected (all zeros 0000 . . . . 0, r of them). If the value on input pair 122-123 is +1 (binary ′b01), then constant 125 is selected (011 . . . 11, total r bits). If the value on input pair 122-123 is −1 (binary ′b11), then constant 126 is selected (10 . . . 01, total r bits). The output of accumulator 131 is latched in the integrator's output register 133. The value in the register 133 can be read in real-time as output representing the amplitude of via r bit output 134. FIG. 7 is a transformation of the measuring device from FIG. 6 to the case of parallel multi-cycle quantum calculation when several consecutive measurements are performed in a single clock. The method accelerates the calculations, albeit requiring more hardware. If some module does not require circuits that memorize the intermediate results (e.g., registers), then acceleration can be achieved by simply repeating the hardware working in parallel. But if the circuit possesses the memory elements, the accelerated solution needs the following approach.

The measuring device from FIG. 6 is a module with memory element which is the accumulator 131. It was discussed already (for FIG. 6) that next value A(t+1) for the accumulator 131 at time moment t+1 (current time t plus one clock) is determined by formula:

A(t+1)=k·(V(t)−A(t))+A(t)=k·V(t)+(1−k)·A(t),

where k is the attenuation coefficient of attenuator 129, value A(t) is the accumulator's 131 current (at time t) value and V(t) is the differentiator's 128 input value measured at time t. Applying the formula for the accumulator's 131 value ten times sequentially, the parallel expression for multi cycle accumulator 162 can be calculated as follows:

Aₜ₊₁₀=k((1−k)⁰·V(t+0)+(1−k)¹·V(t+1)+ . . . +(1−k)⁸·V(t+8)+(1−k)⁹·V(t+9))+(1−k)¹⁰·A(t+0),

where V(t+0), V(t+1), . . . , V(t+8), V(t+9) are 10 consecutive input values to be measured. Considering that these inputs can only take values from a limited set of {0, +1, −1}, the multipliers with coefficients can be simplified to multiplexors with pre-calculated in advance values. For example, if k=0.01 then k(1−k) 8 V(t+8) is a multiplexor with selection between three cases 0.0, +0.009227, −0.009227 of full scale. For the design of an accumulator with a full scale of 15 bits plus a sign bit, the values of the product k·(1−k)⁸·V(t+8) in hexadecimal format will be 0x0000, 0x012E, 0xFED2. The constants go to FIG. 7 items 149, 150, and 151, respectively. The same consideration applies to all other constants starting with item 143 and ending with item 154 in FIG. 7. The feedback gain 164 is the product (1−k)¹⁰ ·A(t+0), where a full multiplier is needed for the multiplication of accumulator's 162 value A(t+0) with the constant 0.904382 of full scale or hexadecimal 0x73C2.

The parallel calculation of 10 consecutive measurements in a single clock requires the hardware depicted in FIG. 7. Ten input multiplexors 155, 156, 157 (represents six not depicted multiplexors), 158, 159 controllable by the input pairs 135-136, 137-138, . . . , 139-140, 141-142. Input values have different weights coded in constants 144, 145, 147, 148, . . . , 150, 151, 153, 154. The weight coefficient calculation was described above. Each input multiplexer is provided with a zero constant 143, 146, . . . , 149, 152, as well. The measuring device also has summer 160 for combining sequential input values V(t+0), V(t+1), . . . , V(t+8), and V(t+9) with applied specific weight coefficients into the overall sum. The adder 161 serves the input of accumulator 162, with a sum from 160 and feedback gain 164. The output register 163 allows the host computer to read the measurement result via r-bit output 165.

FIG. 8 depicts an abstract example of 4 bits scrambler circuit 166, which will be accelerated later with a parallel calculation method, meaning multiple operations per one clock. FIG. 8 shows memory elements (registers) 167, 168, 169, and 170 and CNOT (controlled NOT) quantum gates 171, 172, and 173. The circuit makes one calculation (shift) per one clock.

The presented scrambler implements shifts of the four bit register from the current output values R0(t), R1(t), R2(t), R3(t) to the next clock values R0(t+1), R1(t+1), R2(t+1), R3(t+1) according to the following expressions:

R0(t+1)=V(t)⊕R3(t),

R1(t+1)=R0(t),

R2(t+1)=R1(t),

R3(t+1)=V(t)⊕R3(t)⊕R2(t),

where V(t) is the current value on general input 166 at time t and the sign ⊕ is CNOT (quantum controlled NOT) operation. The register values can be measured at outputs 174, 175, 176 and 177.

Parallel calculations increase the circuit's performance without increasing the system clock frequency, which is often impossible due to the physical limitations of real integrated circuits. The method of parallel calculations allows digital circuits to mimic the behavior of the real quantum processors and approach their performance. For example, the quantum effects based on an electron's spin toggling have a characteristic frequency of 2 GHz. Suppose the integrated circuit runs at 200 MHz and has 10 parallel calculations in one 200 MHz clock. In that case, the overall frequency of operation will be 2 GHz, and the presented circuit's performance and behavior will be indistinguishable from the results of a quantum processor based on the physical phenomenon of the electron's spin toggling. The transformation of the scrambler from FIG. 8 to the tenfold accelerated form (with the help of the parallel calculation method) is shown in FIG. 9. The presented acceleration hardware makes 10 iterations (scrambler's shifts) per single clock.

To perform the parallel operations—pre-calculations are required. The four-bit register values R0, R1, R2, and R3 need to be split into 10 timing strata which are represented by register output values at time intervals t+0, t+1, . . . , t+9:

{R0(t+0),R1(t+0),R2(t+0),R3(t+0)},{R0(t+1),R1(t+1),R2(t+1),R3(t+1)}, . . . , {R0(t+9),R1(t+9),R2(t+9),R3(t+9)}.

For the scrambler's register R0, R1, R2, R3 the corresponding shift values for the next 10 time intervals t+10, t+11, . . . , t+19 are pre-calculate as follows:

$$R 0 ( t + 10 ) = V ( t + 0 ) ⊕ R 3 ( t + 9 )$$

$$R 1 ( t + 10 ) = R 0 ( t + 9 )$$

$$R 2 ( t + 10 ) = R 1 ( t + 9 )$$

$$R 3 ( t + 10 ) = V ( t + 0 ) ⊕ R 3 ( t + 9 ) ⊕ R 2 ( t + 9 )$$

$$R 0 ( t + 11 ) = V ( t + 0 ) ⊕ V ( t + 1 ) ⊕ R 3 ( t + 9 ) ⊕ R 2 ( t + 9 )$$

$$R 1 ( t + 11 ) = V ( t + 0 ) ⊕ R 3 ( t + 9 )$$

$$R 2 ( t + 11 ) = R 0 ( t + 9 )$$

$$R 3 ( t + 11 ) = V ( t + 0 ) ⊕ V ( t + 1 ) ⊕ R 3 ( t + 9 ) ⊕ R 2 ( t + 9 ) ⊕ R 1 ( t + 9 ) ]$$

$$⋮$$

$$R 0 ( t + 19 ) = V ( t + 1 ) ⊕ V ( t + 2 ) ⊕ V ( t + 4 ) ⊕ V ( t + 6 ) ⊕ V ( t + 7 ) ⊕ V ( t + 8 ) ⊕ V ( t + 9 ) ⊕ R 2 ( t + 9 ) ⊕ R 1 ( t + 9 )$$

$$R 1 ( t + 19 ) = V ( t + 0 ) ⊕ V ( t + 1 ) ⊕ V ( t + 3 ) ⊕ V ( t + 5 ) ⊕ V ( t + 6 ) ⊕ V ( t + 7 ) ⊕ V ( t + 8 ) ⊕ R 3 ( t + 9 ) ⊕ R 2 ( t + 9 ) ⊕ R 0 ( t + 9 )$$

$$R 2 ( t + 19 ) = V ( t + 0 ) ⊕ V ( t + 2 ) ⊕ V ( t + 4 ) ⊕ V ( t + 5 ) ⊕ V ( t + 6 ) ⊕ V ( t + 7 ) ⊕ V ( t + 8 ) ⊕ R 3 ( t + 9 ) ⊕ R 1 ( t + 9 )$$

$$R 3 ( t + 19 ) = V ( t + 2 ) ⊕ V ( t + 3 ) ⊕ V ( t + 5 ) ⊕ V ( t + 7 ) ⊕ V ( t + 8 ) ⊕ V ( t + 9 ) ⊕ R 1 ( t + 9 ) ⊕ R 0 ( t + 9 )$$

where V(t+0), V(t+1), . . . , V(t+9) are input values at 10 consecutive moments of time t+0, t+1, . . . , t+9 provided via input ports 178, 179, 180, 181, 182, 183, 184, 185, 186, 187 and the sign ⊕ is a CNOT (quantum controlled NOT) operation.

The register bit values R0, R1, R2, R3 for the time intervals t+0, t+1, . . . , t+9 and then next clock for the time intervals t+10, t+11, . . . , t+19 are available at output ports 242, 243, 244, 245, 246, 247, 248, 249, 250, 251, 252, 253. The values can be used for the parallel method of quantum circuit measurement as described in FIG. 7.

We claim:

1. An architecture and synthesizable code for an on-chip quantum computer electronic circuit for the generation of a sequence of random bits with the ability to change the amplitude and polarity of the probability of the complex superposition of the orthogonal states and with controllable noise injection for quantum bits and quantum gates emulation comprising:
a. a linear shift m-bit register generating 2^{m}−1 numbers;
b. a random disturber stopping the linear shift register from advancing at a rate slower than the linear shift register clock;
c. an m-bit register for storing a value of the desired probability of the orthogonal states;
d. an m-bit register for storing a value of the desired level of noise; and
e. a quantizer (arithmetical comparator between the value of the linear shift register and the value stored in the first programmable m-bit register) for driving its output proportionally to the programmed amplitude of probability and for injecting the noise controllable by the second m-bit register randomly;
f. a polarity and noise injection logic for assigning polarity to probability amplitude quantizer output and for the noise injection;
g. a register programmability for setting the amplitude of probability, polarity, and noise level injection separately for each quantum bit orthogonal state, separately for each quantum gate matrix term, and separately for their real and imaginary parts, all made through specialized software platform for quantum computation.

2. Specialized multiplier, adder, and computation residue storage for quantum matrix dot complex product operations which do not increase the bit width of the circuit's output compared to the bit width of the circuit's inputs, which makes the circuit suitable for creation unlimited in length the chains of quantum gates (quantum processors), comprising:
a. Multipliers working with a restricted set of possible input values with a minimum set of {0, +1, −1};
b. Full adders and subtractors for dot product calculation;
c. Residue register for retaining the value from the preceding calculation step;
d. The residue storage register and logic for limiting the output result value to the set of values selected for the input values without losing information.

3. A parallel method of operation of the invented synthesizable electronic circuits, including circuits with memory elements, for increasing the effective speed of quantum computations.
